(19) United States
(12) Patent Application Publication
(10) Pub. No.: US 2023/0082903 A1
(43) Pub. Date: Mar. 16, 2023

(54) AUTONOMIC APPLICATION SERVICE FRAMEWORK

(71) Applicants: Ramesh Subrahmaniam, Aldie, VA (US); Madhukar Anand, Fremont, CA (US)

(72) Inventors: Ramesh Subrahmaniam, Aldie, VA (US); Madhukar Anand, Fremont, CA (US)

(21) Appl. No.: 17/471,331

(22) Filed: Sep. 10, 2021

(51) Int. Cl. H04L 12/24

(52) U.S. Cl. CPC H04L 41/5009; H04L 41/5096; H04L 41/5048

(57) ABSTRACT

The present invention provides a Learn. Map, Measure and Assure (LEMMA) framework deployed as multi-cloud platform. The LEMMA framework comprises a learn module configured to receive a service level agreement, convert the service level agreement to a service level objective, refine the service level objective and store the service level objective in machine-readable record, and a map module configured to determine a list of available resources via a service broker. The service broker is configured to select a best priced resources from a list of available resources that matches with the machine-readable service level objective. A measure module configured to generate monitored data by continuously monitoring the allocated best priced resources. An assure module configured to perform iterative refinement of the machine-readable service level objective in response to comparison of the machine-readable service level objective with the monitored data and transmit the refined service level objective to the service broker.

### FIELD OF THE INVENTION

The present invention relates to an application service framework configured to discover, allocate and monitor resources of an application.

### BACKGROUND OF THE INVENTION

Cloud computing platforms, operated by a cloud operator, allow application owners to execute their software applications without owning the computing resources that the software applications use to execute. A cloud computing platform includes a pool of computing resources, including hardware such as processors and storage devices. This pool of resources can be partitioned and can be allocated to execute a software application for an application owner. Some platforms partition the resources into virtual machines and each virtual machine can be instantiated and configured to execute a software application. Different virtual machines can be configured to execute different software applications. As a result, the cloud computing platform can be used to execute many different software applications on behalf of multiple application owners.

To execute software applications on the cloud platform, each application owner contracts with the cloud operator. The contracts between the application owner and the cloud operator define categories of virtual machines that are available for executing the software application-/. such as virtual machines with small, medium, and large amounts of hardware resources—and a billing rate associated with each of the virtual machines. Under the contract, the cloud operator is responsible for making the virtual machines available upon request by the application owner. The application owner is responsible for determining when to request additional resources, what category of resources to request, and when to release those resources back to the cloud computer platform. When the software application is executed and resources of the platform are requested and used by the software application, the cloud operator then bills the application owner for the time used on the requested resources at the rate set under the contract.

Resource allocation is important aspects of cloud computing. In cloud computing enormous cloud users can request collective services of cloud concomitantly. So, there must be a provision that all resources are made available to requesting user in efficient manner to satisfy their need.

Therefore, a framework is needed that provides automated allocation of the best priced resources and continuous monitoring of the allocated resources to achieve a service level objective.

### SUMMARY OF THE INVENTION

Embodiments of the present invention provides an application service framework deployed as a multi-cloud platform, comprising modules to discover, allocate and monitor resources of an application. The application service framework comprises an input module configured to receive service level agreement (SLA), a natural language processing (NLP) module configured to receive the service level agreement (SLA) requirements from the input module and convert the service level agreement (SLA) requirements into a service level objective (SLO), and perform iterative refinement of the service level objective (SLO) in response to a comparison of the service level objective (SLO) to one or more predefined threshold values of a service level indicator (SLI) related to the application. The natural language processing (NLP) module is configured to convert the refined service level objective (SLO) and the service level indicator into a machine-readable format. Further, the natural language processing (NLP) module is configured to store the machine-readable service level objective (SLO), and the service level indicator (SLI) in a database. The natural language processing (NLP) module is configured to transmit the machine-readable service level objective (SLO) to the service broker. The service broker is configured to determine a list of available resources for the deployment of the application, select the best priced resources from the list of available resources that matches with the machine-readable service level objective (SLO) and allocate the selected best priced resources across the multiple clouds for the deployment of the application. Further, a monitoring module is configured to monitor the allocated best-priced resources of the deployed application and generate a monitored data. The monitoring module is configured to transmit the monitored data to a reinforcement leaning module. The reinforcement learning module is configured to extract the machine-readable service level objective (SLO) from the database. The reinforcement learning module is configured to perform iterative refinement of the machine-readable service level objective (SLO) in response to the comparison of the machine-readable service level objective (SLO) with the monitored data and transmit the refined machine-readable service level objective (SLO) to the service broker.

In one embodiment, the present invention provides a Learn. Map, Measure and Assure (LEMMA) framework deployed as a multi-cloud platform. The Learn. Map. Measure and Assure (LEMMA) framework comprising modules to discover, allocate and monitor resources of an application. The LEMMA framework comprising a learn module configured to receive service level agreement (SLA) requirements for an application, convert the service level agreement (SLA) requirements into a service level objective (SLO), and perform iterative refinement of the service level objective (SLO), in response to comparison of the service level objective (SLO) with one or more predefined threshold values of a service level indicator (SLI) related to the application. The learn module is configured to convert the refined service level objective (SLO) and the service level indicator into a machine-readable format and store the machine-readable service level objective (SLO), and the service level indicator (SLI) in a database. Further, the learn module is configured to transmit the machine-readable service level objective (SLO) to a map module. The map module comprises a service broker that is configured to receive the machine-readable service level objective (SLO), determine a list of available resources for the deployment of the application in response to the received machine-readable service level objective (SLO), select a best priced resources from the list of available resources matching with the machine-readable service level objective (SLO) and allocate the selected best priced resources. The measure module is configured to generate monitored data by continuously monitoring the allocated best priced resources of the application and transmit the monitored data to an assure module. The assure module is configured to extract the machine-readable service level objective (SLO) from the database, perform iterative refinement of the machine-readable service level objective (SLO) in response to comparison of the machine-readable service level objective (SLO) with the monitored data using a reinforcement learning module and transmit the refined machine-readable service level objective (SLO) to the service broker.

In one exemplary embodiment, the service level agreement (SLA) requirements comprise at least one of a but not limited to a geographical location, type of cloud, credentials to one or more cloud, pricing constraints, availability requirements, security requirements (compliance requirements), application performance requirements, and infrastructure requirements. The performance requirement is latency and throughput. The infrastructure requirement is at least one of a vCPU/CPU, speed of network interface. GPUs. and TensorFlow units.

In another exemplary embodiment, the service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery.

In yet another exemplary embodiment, the monitored data is selected from a group consisting of a bandwidth, network latency, failure of vCPUs. CPU utilization. DB/network performance and 99.99% uptime.

### BRIEF DESCRIPTION OF THE DRAWINGS

Embodiments of the present invention described herein are exemplary, and not restrictive. Embodiments will now be described, by way of examples, with reference to the accompanying drawings, in which:

FIG. 1 illustrates a block diagram of the application service framework having a closed-loop system in accordance with a preferred embodiment of the present invention.

FIG. 2 illustrates a process flow diagram of an application service framework in accordance with an exemplary embodiment of the present invention.

FIG. 3 is block diagram of a Learn, Map, Measure and Assure (LEMMA) framework, in accordance with an exemplary embodiment of the present invention.

### DETAILED DESCRIPTION OF THE INVENTION

With reference to the figures provided, embodiments of the present invention are now described in detail. In the following description, for purposes of explanation, numerous specific details are set forth in-order to provide a thorough understanding of the invention. It will be apparent, however, to one skilled in the art that the invention can be practiced without these specific details. In other instances, structures, devices, activities, and methods are shown using schematics, use cases, and/or flow diagrams in-order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The term “cloud” refers to one or more connected resources i.e., vCPU/CPU, storage, and other computing resources to efficiently run one or more applications. The cloud storage comprises of network-attached services (NAS), storage area network (SAN), and data centers/colocation (DC/Colo).

Service level agreement (SLA) can be an or implicit contract with a set of users that includes consequences of meeting (or missing) the SLOs they contain. Service level objective (SLO) is a service level objective: a target value or range of values for a service level that is measured by an SLI. Service level indicator (SLI) can be a carefully defined quantitative measure of some aspect of the level of service that is provided. Example SLIs can include, inter ala: latency, error rate, system throughput, etc.

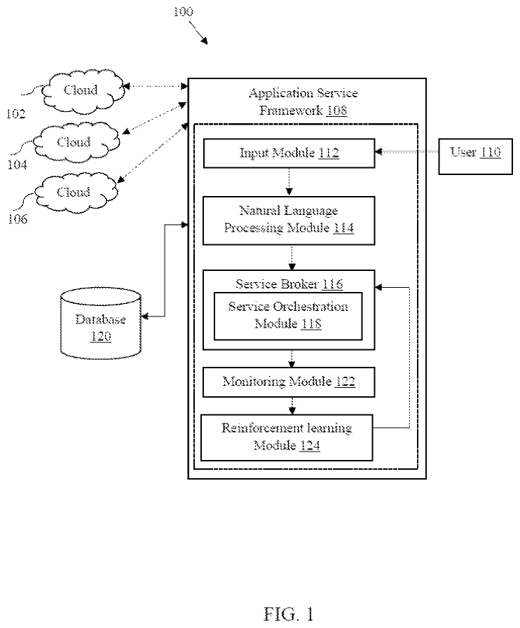

FIG. 1 illustrates a block diagram of the application service framework (108) having a closed-loop system (100) in accordance with a preferred embodiment of the present invention. The application service framework (108) deployed as a multi-cloud platform (102, 104, 106), comprising modules to discover, allocate and monitor resources of an application. The multi-cloud platform (102, 104, 106) comprises one or more public, private, hybrid, and edge clouds or any combination thereof. The hybrid cloud is a combination of public and private clouds. The application service framework (108) comprises an input module (112), a natural language processing module (114), a service broker (116), a service orchestration module (118), a monitoring module (122), and a reinforcement learning module (124).

The input module (112) is configured to receive input from a user (110) or an infrastructure. The input is a service level agreement (SLA) requirement for an application/enterprise resource planning (ERP). Enterprise Resource Planing (ERP) refers to software and systems used to plan and manage all the core supply chain, manufacturing, services, financial and other processes of an organization. The service level agreement (SLA) requirements comprise at least one of a but not limited to a geographical location, type of cloud, credentials to one or more cloud, pricing constraints, availability requirements, security requirements (compliance requirements), application performance requirements, and infrastructure requirements. The performance requirement is latency and throughput. The infrastructure requirement is at least one of a vCPU/CPU, speed of network interface. GPUs. and TensorFlow units.

The natural language processing (NLP) module (014) is configured to receive the service level agreement (SLA) requirements from the input module (112) and convert the service level agreement (SLA) requirements into a service level objective (SLO). The service level objective (SLO) comprises a plurality of objectives corresponding to the service level agreement (SLA) requirements. The service level objective (SLO) is a prioritized list of objectives required for deployment of the application. The service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery. The natural language processing (NLP) module (114) is configured to perform iterative refinement of the service level objective (SLO) in response to a comparison of the service level objective (SLO) to one or more predefined threshold values of a service level indicator (SLI) related to the application. The one or more predefined threshold values of a service level indicator (SLI) related to the application are extracted from a database (120).

The natural language processing (NLP) module (114) is configured to convert the refined service level objective (SLO) and the service level indicator into a machine-readable format. Further, the natural language processing (NLP) module (114) is configured to store the machine-readable service level objective (SLO), and the service level indicator (SLI) in the database (120). The natural language processing (NLP) module 114) is configured to transmit the machine-readable service level objective (SLO) to the service broker (116).

The service broker (116) is configured to determine a list of available resources for the deployment of the application. The list of available resources comprises at least one of the but not limited to a topology, links, nodes, vCPU/CPU, distributed block storage or database, and cloud storage. The service broker (116) is configured to select the best priced resources from the list of available resources that matches with the machine-readable service level objective (SLO). The selected best-priced resources are allocated for the deployment of the application via a service orchestration module (118). The service orchestration module (18) is coupled to a scheduler. The scheduler enables the service orchestration module (118) to allocate the selected best priced resources across the multiple clouds (102, 104, 106) for the deployment of the application.

The monitoring module (122) is configured to monitor the allocated best-priced resources of the deployed application and generate a monitored data. The generated monitored data is stored in database in a specific format. The monitored data is selected from a group consisting of a bandwidth, network latency, failure of vCPUs. CPU utilization, DB/network performance and 99.99% uptime. The monitoring module (122) is configured to transmit the monitored data to the reinforcement learning module (124i. The reinforcement learning module (124) is configured to extract the machine-readable service level objective (SLO) front the database (120). The reinforcement learning module (124) is configured to perform iterative refinement of the machine-readable service level objective (SLO) in response to the comparison of the machine-readable service level objective (SLO) with the monitored data. Further, the reinforcement learning module (124) is configured to transmit the refined machine-readable service level objective (SLO) to the service broker (116). The service broker (116) is configured to determine the list of available resources for the deployment of the application corresponding to the refined machine-readable service level objective (SLO).

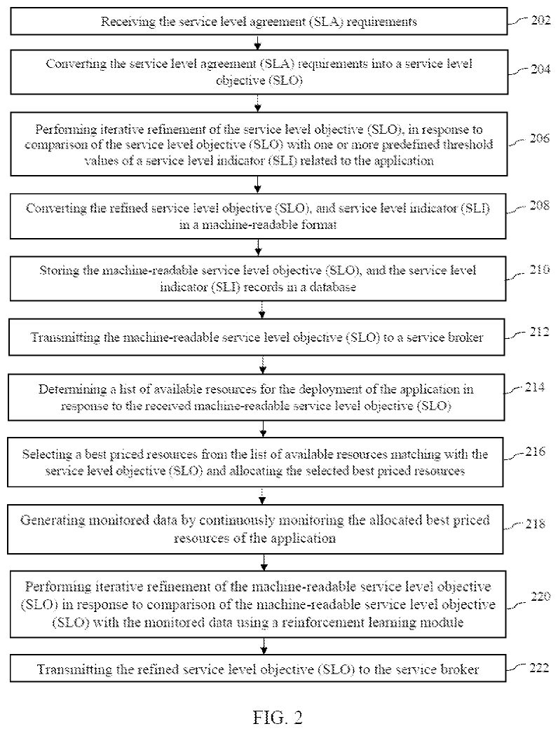

FIG. 2 illustrates a process flow diagram of an application service framework in accordance with an exemplary embodiment of the present invention. The application service framework is configured to discover, allocate and monitor resources of an application. The application services framework is executable by a hardware processor. The application services framework is configured for receiving an input from a user or an infrastructure, in step (202). The input is a service level agreement (SLA) requirement for an application/enterprise resource planning (ERP). The service level agreement (SLA) requirements comprise at least one of a geographical location, type of cloud, credentials to one or more cloud, pricing constraints, availability requirements, security requirements (compliance requirements), application performance requirements, and infrastructure requirements such as vCPU/CPU, speed of network interface, GPUs. and TensorFlow units.

In step (204), converting the service level agreement (SLA) requirements into a service level objective (SLO). As used herein, the service level objective (SLO) comprises a plurality of objectives corresponding to the service level agreement (SLA) requirements. The service level objective (SLO) comprises at least one of a transactional database, link bandwidth 100 G, 100 virtual central processing unit (vCPUS), secure with 256 secure hash algorithms (SHA), network latency 100 ms, 99.99% 4 uptime, disaster recovery. In step (206), performing iterative refinement of the service level objective (SLO), in response to comparison of the service level objective (SLO) with one or more predefined threshold values of a service level indicator (SLI) related to the application. In step (208), converting the refined service level objective (SLO) and the service level indicator (SLI) into a machine-readable format. In step (210), storing the refined machine-readable service level objective (SLO), along with the service level indicator (SLI) records in a database. In step (212), transmitting the machine-readable service level objective (SLO) to a service broker. In step (214), determining a list of available resources for the deployment of the application in response to the received machine-readable service level objective (SLO). In step (216), selecting a best priced resources from the list of available resources matching with the machine-readable service level objective (SLO) and allocating the selected best priced resources. In step (218), generating monitored data by continuously monitoring the allocated best priced resources of the application. The monitored data is selected from a group consisting of a bandwidth, network latency, failure of vCPUs. CPU utilization. DB/network performance and 99.99% uptime. Further, in step (220), performing iterative refinement of the machine-readable service level objective (SLO) in response to comparison of the machine-readable service level objective (SLO) with the monitored data using a reinforcement learning module. At last, in step (222), transmitting the refined service level objective (SLO) to the service broker. The service broker is further configured for determining the best priced resources from the list of available resources matching with the refined service level objective (SLO).

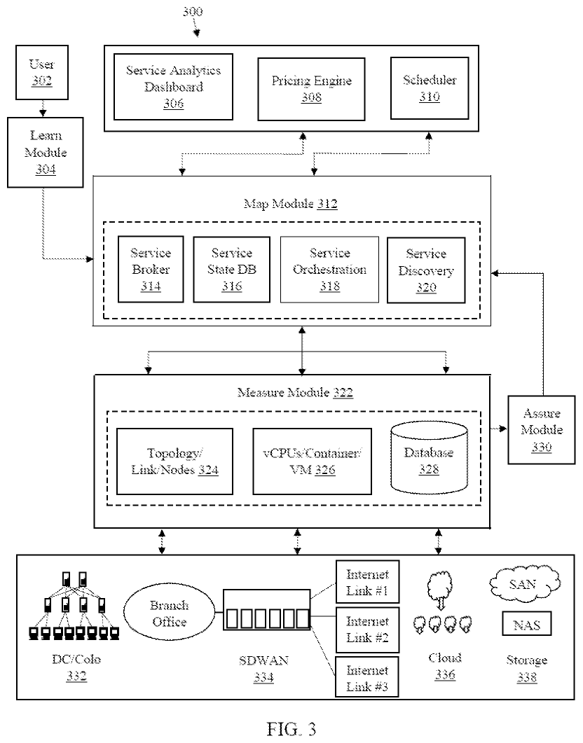

FIG. 3 is block diagram of a Learn. Map, Measure and Assure (LEMMA) framework (300), in accordance with an exemplary embodiment of the present invention. The Learn. Map. Measure and Assure (LEMMA) framework (300) is configured to discover, allocate and monitor resources of the application. The Learn. Map. Measure and Assure (LEMMA) framework (300) comprising a learn module (304), a map module (312), a measure module (322), and an assure module (330). The learn module (304) is configured to receive service level agreement (SLA) requirements for the application from a user 302). The service level agreement (SLA) requirements comprise at least one of a geographical location, type of cloud, credentials to one or more cloud, pricing constraints, availability requirements, security requirements (compliance requirements), application performance requirements, and infrastructure requirements. The infrastructure requirement comprises at least one of a vCPU/CPU, speed of network interface. GPUs. and TensorFlow units. The learn module (304) is configured to convert the service level agreement (SLA) requirements into a service level objective (SLO). The service level objective (SLO) comprises a plurality of objectives corresponding to the service level agreement (SLA) requirements. The service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery.

Further, the learn module (304) is configured to perform iterative refinement of the service level objective (SLO), in response to comparison of the service level objective (SLO) with one or more predefined threshold values of a service level indicator (SLI) related to the application. The learn module (304) is configured to convert the refined service level objective (SLO) and the service level indicator into a machine-readable format, and store the machine-readable service level objective (SLO), and the service level indicator (SLI) in a database. Further, the learn module (304) is configured to transmit the machine-readable service level objective (SLO) to the map module (312). The map module (312) comprises of a service broker (314), a service state database (316), a service orchestration (318), and a service discovery (320). The service broker (314) is configured to receive the machine-readable service level objective (SLO). The service broker (314) is configured to determine a list of available resources via the service discovery (320). The service broker 1314) is configured to select a best priced resources from the list of available resources that matches with the machine-readable service level objective (SLO) using a pricing engine (308). The map module (312) is further configured to allocate the best priced resources selected by the service broker (314) via the service orchestration (318). The service orchestration (318) is coupled to a scheduler (310). The scheduler (310) enables the service orchestration (318) to allocate the best priced resources to the application, in one example, the user is enabled to view the list of allocated resources via a service analytics dashboard (306).

The measure module (322) is configured to generate monitored data by continuously monitoring the allocated best priced resources of the application. The monitored data is selected from a group consisting of a bandwidth, network latency, failure of vCPUs. CPU utilization. DB/network performance and 99.99% uptime. The measure module (322) is configured to receive the monitored data from the allocated resources such as topology/link/nodes (324), vCPUs/Container/Virtual memory (VM) (326), and one or more cloud-based databases (328). The topology/link/nodes (324) are DC/COLO i.e., colocation center. The vCPUs/Container/Virtual memory (VM) (326) is SDWAN (Sofware-defined Wide Area Network (SD-WANs. Further, the one or more cloud-based databases (328) includes cloud (336), and at least one of a storage i.e., SAN (storage area network). NAS (network-attached storage). The measure module (322) is configured to transmit the monitored data to the assure module (330). The assure module (330) is configured to extract the machine-readable service level objective (SLO) from the database. The assure module (330) is configured to perform iterative refinement of the machine-readable service level objective (SLO) in response to comparison of the machine-readable service level objective (SLO) with the monitored data using a reinforcement learning module. Further, the assure module (330) is configured to transmit the refined machine-readable service level objective (SLO) to the service broker (314) of the map module (312).

In one exemplary embodiment, the monitored data is stored in a public and subscribe database. The user is enabled to generate a profile. The user is enabled to view the monitored data of the application. The user is enabled to share the monitor data with other users of the LEMMA framework.

While the invention has been described with respect to preferred embodiments, those skilled in the art will readily appreciate that various changes and/or modifications can be made to the invention without departing from the spirit or scope of the invention as defined by the appended claims.

It will be apparent to those skilled in the art that many further modifications and adaptations can be made. The particular embodiments are not provided to limit the concept but to illustrate it. The scope of the embodiments is not to be determined by the specific examples provided above but only by the claims below.

1. An application services framework having a closed loop system, deployed as a multi-cloud platform, comprising modules to discover, allocate and monitor resources of an application, wherein the application services framework comprising:
an input module configured to receive service level agreement (SLA) requirements for an application from a user, wherein SLA is an implicit contract;
a natural language processing module configured to:
receive the service level agreement (SLA) requirements from the input module;
convert the service level agreement (SLA) requirements into a service level objective (SLO), wherein the service level objective (SLO) comprises one or more target values and a plurality of objectives corresponding to the service level agreement (SLA) requirements;
convert the service level objective (SLO) into a machine-readable format;
store the machine-readable service level objective (SLO) in a database;
transmit the machine-readable service level objective (SLO) to a service broker;
wherein, the service broker is configured to perform the following steps:
(a) determine a list of available resources for the deployment of the application;
(b) select one or more best resources from the list of available resources matching with the machine-readable service level objective (SLO); and
(c) allocate the selected best resources for the deployment of the application via a service orchestration module;
a monitoring module configured to:
generate monitor data by continuously monitoring the allocated best resources of the application;
transmit the monitor data to a reinforcement learning module,
wherein, the reinforcement learning module is configured to:
extract the machine-readable service level objective (SLO) from the database;
perform iterative refinement of the plurality of objectives of the machine-readable service level objective (SLO) in response to comparison of the machine-readable service level objective (SLO) with the monitored data; and
transmit the refined machine-readable service level objective (SLO) to the service broker.

2. (canceled)

3. The application services framework of claim 1, wherein the service level agreement (SLA) requirements comprise at least one of a geographical location, type of cloud, credentials to one or more cloud, pricing constraints, availability requirements, security requirements (compliance requirements), application performance requirements, and infrastructure requirements.

4. The application services framework of claim 1, wherein the infrastructure requirement comprises at least one of a vCPU/CPU, speed of network interface, GPUs, and TensorFlow units.

5. The application services framework of claim 1, wherein the service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery.

6. The application services framework of claim 1, wherein the monitor data is selected from a group consisting of a bandwidth, network latency, failure of vCPUs, CPU utilization, DB/network performance and 99.99% uptime.

7. An application services framework deployed as a multi-cloud platform, comprising modules to discover, allocate and monitor resources of an application, wherein the application services framework executable by a hardware processor, wherein the application services framework comprising:
receiving service level agreement (SLA) requirements for an application from a user, wherein SLA is an implicit contract:
converting the service level agreement (SLA) requirements into a service level objective (SLO), wherein the service level objective (SLO) comprises one or more target values and a plurality of objectives corresponding to the service level agreement (SLA) requirements;
converting the service level objective (SLO) into a machine-readable format;
storing the machine-readable service level objective (SLO), in a database;
transmitting the machine-readable service level objective (SLO) to a service broker;
wherein, the service broker is configured to perform the following steps:
(a) receiving the service level objective (SLO);
(b) determining a list of available resources for the deployment of the application in response to the received machine-readable service level objective (SLO);
(c) selecting one or more best resources from the list of available resources matching with the service level objective (SLO); and
(d) allocating the selected best resources;
generating monitored data by continuously monitoring the allocated best resources of the application;
extracting the machine-readable service level objective (SLO) from the database;
performing iterative refinement of the plurality of objectives of the machine-readable service level objective (SLO) in response to comparison of the machine-readable service level objective (SLO) with the monitored data using a reinforcement learning module; and
transmitting the refined service level objective (SLO) to the service broker.

8. (canceled)

9. The application services framework of claim 7, wherein the service level agreement (SLA) requirements comprise at least one of a geographical location, type of cloud, credentials to one or more cloud, pricing constraints, availability requirements, security requirements (compliance requirements), application performance requirements, and infrastructure requirements.

10. The application services framework of claim 7, wherein the infrastructure requirement comprises at least one of a vCPU/CPU, speed of network interface, GPUs, and TensorFlow units.

11. The application services framework of claim 7, wherein the service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery.

12. The application services framework of claim 7, wherein the monitored data is selected from a group consisting of a bandwidth, network latency, failure of vCPUs, CPU utilization, DB/network performance and 99.99% uptime.

13. A Learn, Map, Measure and Assure (LEMMA) framework deployed as a multi-cloud platform, comprising modules to discover, allocate and monitor resources of an application, wherein the LEMMA framework comprising: a learn module configured to:
receive service level agreement (SLA) requirements for an application from a user, wherein SLA is an implicit contract:
convert the service level agreement (SLA) requirements into a service level objective (SLO), wherein the service level objective (SLO) comprises one or more target values and a plurality of objectives corresponding to the service level agreement (SLA) requirements;
convert the refined service level objective (SLO) into a machine-readable format;
store the machine-readable service level objective (SLO) in a database;
transmit the machine-readable service level objective (SLO) to a map module;
wherein, the map module comprises a service broker configured to perform the following steps:
receive the machine-readable service level objective (SLO);
determine a list of available resources for the deployment of the application in response to the received machine-readable service level objective (SLO);
select one or more best resources from the list of available resources matching with the machine-readable service level objective (SLO); and
allocate the selected best resources;
a measure module configured to:
generate monitored data by continuously monitoring the allocated best resources of the application;
transmit the monitored data to an assure module;
wherein, the assure module is configured to:
extract the machine-readable service level objective (SLO) from the database;
perform iterative refinement of the plurality of objectives of the machine-readable service level objective (SLO) in response to comparison of the machine-readable service level objective (SLO) with the monitored data; and
transmit the refined machine-readable service level objective (SLO) to the service broker.

14. The LEMMA framework of claim 13, wherein the service level agreement (SLA) requirements comprise at least one of a geographical location, type of cloud, credentials to one or more cloud, pricing constraints, availability requirements, security requirements (compliance requirements), application performance requirements, and infrastructure requirements.

15. The LEMMA framework of claim 13, wherein the infrastructure requirement comprises at least one of a vCPU/CPU, speed of network interface, GPUs, and TensorFlow units.

16. The LEMMA framework of claim 13, wherein the service level objective (SLO) comprises at least one of a transactional database, link bandwidth 100 G, 100 virtual central processing unit (vCPUs), secure with 256 secure hash algorithms (SHA), network latency 100 ms, 99.99% uptime, disaster recovery.

17. The application services framework of claim 13, wherein the monitored data is selected from a group consisting of a bandwidth, network latency, failure of vCPUs, CPU utilization, DB/network performance and 99.99% uptime.
